(19) United States
(12) Patent Application Publication
(10) Pub. No.: US 2020/0408010 A1
(43) Pub. Date: Dec. 31, 2020

(54) LOCK MECHANISM

(71) Applicant: TOYODA GOSEI CO., LTD., Kiyosu-shi (JP)

(72) Inventor: Hiroki TAKAI, Kiyosu-shi (JP)

(21) Appl. No.: 16/897,683

(22) Filed: Jun. 10, 2020

(30) Foreign Application Priority Data
Jun. 28, 2019 (JP) 2019-122160

(51) Int. Cl. E05B 83/30; E05B 79/14; E05B 85/08

(52) U.S. Cl. CPC E05B 83/30; E05B 79/14; E05B 85/08; E05Y 2900/538; E05Y 2201/686; E05Y 2201/706; E05Y 2201/626

(57) ABSTRACT

A lock mechanism, includes: a rotor including a rotor rotation axis, a pair of rod connecting portions, and a pressure receiving surface; a knob including a knob rotation axis and a pressing portion; a locking portion including a pair of rods; a rotor urging member; and a knob urging member. During an opening operation in which the knob rotates from a normal position to a release operation position, the pressing portion pushes the pressure receiving surface while sliding on the pressure receiving surface to rotate the rotor from a lock input position to a release input position, and a length, obtained by projecting a sliding locus of the pressing portion on the pressure receiving surface on a cross-section in an axial perpendicular direction of the rotor, is not less than 0.8 times a length, by which the position of the pressing portion has been actually changed.

### CROSS-REFERENCE TO RELATED APPLICATION(S)

This application is based upon and claims the benefit of priority from prior Japanese patent application No. 2019-122160 filed on Jun. 28, 2019, the entire contents of which are incorporated herein by reference.

### BACKGROUND

### 1. Field of the Invention

The present invention relates to a lock mechanism for locking an object.

### 2. Description of the Related Art

In recent years, various lock mechanisms have been known for locking an object. For example, as a lock mechanism mounted on a glove box of a vehicle, a side-lock type or a bar type lock mechanism has been known (see, for example, JP-A-2007-100343). In the present specification, the side-lock type lock mechanism for the glove box is referred to as the side lock mechanism of the glove box or simply the side lock mechanism, as necessary.

The glove box is attached to an instrument panel of a vehicle and changes its state between a closed position that closes an opening provided in the instrument panel and an open position that opens the opening. The side lock mechanism is attached to the glove box and locks the glove box in the closed position.

More specifically, the side lock mechanism has a pair of rods, a rotor for changing the state of the rods between a locked position and a released position, and a knob for operating the rotor. The rotor and rod are placed on the back side of a lid in the glove box and the knob is exposed on the front side of the lid.

In such a side lock mechanism, the rod in the locked position locks the glove box in the closed position by locking with lock receiving portions provided on both sides of the lid in the instrument panel. Further, in this case, the position of the knob is changed by the operation of a user and the rotor is rotated accordingly, so that the position of the rod is also changed from the locked position to the released position. Then, the lock between the rod and the lock receiving portion is released and the lock of the glove box is released. That is, in this case, the state of the glove box can be changed to the open position.

In the side lock device introduced in JP-A-2007-100343 described above, a rotor is rotated by rotating a knob supported by a glove box. As a result, the rod slides while tilting and the state changes from the locked position to the released position.

In this kind of side lock mechanism, the state change amount of the rod and the state change amount of the knob are closely related. In order to reliably lock an object such as a glove box and to unlock the lock with high reliability, the state change amount of the rod must be large to some extent. On the other hand, the knob operated by a user is required to have a state change amount that is not so large in some cases.

For example, since the knob is exposed on the surface of an object such as a glove box for the convenience of operation by a user, miniaturization of the knob is required from the viewpoint of designability and the like.

In the case of a rotary type knob as described in JP-A-2007-100343, when miniaturizing the knob, in order to secure a sufficient state change amount, it is necessary to increase a rotation angle of the knob. In this case, the amount of movement of a user required to operate the knob increases, and thus the usability of the side lock mechanism may be impaired.

### SUMMARY

The inventor of the invention has aimed to improve the operability of a lock mechanism so that a state change amount of a rod can be sufficiently secured even when a state change amount of a knob is small, and an object of the invention is to provide a lock mechanism with improved operability.

According to an aspect of the invention, there is provided a lock mechanism, including: a rotor including a rotor rotation axis, a pair of rod connecting portions located radially outside of the rotor rotation axis, and a pressure receiving surface located radially outside of the rotor rotation axis, the rotor configured to rotate between a lock input position and a release input position around the rotor rotation axis; a knob including a knob rotation axis and a pressing portion located radially outside of the knob rotation axis, the knob configured to rotate between a normal position and a release operation position around the knob rotation axis; a locking portion including a pair of rods respectively connected to one and the other of the pair of rod connecting portions, the locking portion configured to change its state between a locked state and a released state with rotation of the rotor between the lock input position and the release input position; a rotor urging member configured to urge the rotor to the lock input position; and a knob urging member configured to urge the knob to the normal position, wherein during an opening operation in which the knob rotates from the normal position to the release operation position, the pressing portion of the knob pushes the pressure receiving surface while sliding on the pressure receiving surface of the rotor to rotate the rotor from the lock input position to the release input position, and a length, obtained by projecting a sliding locus of the pressing portion on the pressure receiving surface on a cross-section in an axial perpendicular direction of the rotor, is not less than 0.8 times a length, by which the position of the pressing portion has been actually changed.

The lock mechanism of the invention has excellent operability.

### BRIEF DESCRIPTION OF DRAWINGS

The present invention will become more fully understood from the detailed description given hereinbelow and the accompanying drawing which is given by way of illustration only, and thus is not limitative of the present invention and wherein:

FIG. 1 is an explanatory diagram schematically illustrating a lock mechanism according to a first example mounted on a vehicle and a glove box including the lock mechanism;

FIG. 2 is an explanatory view schematically illustrating a disassembled state of the lock mechanism of the first example;

FIG. 3 is an explanatory diagram schematically illustrating operations of a knob and a rotor in the lock mechanism of the first example;

FIG. 4 is an explanatory view schematically illustrating the operation of the knob and the rotor in the lock mechanism of the first example;

FIG. 5 is an explanatory diagram schematically illustrating the operation of the knob and the rotor in the lock mechanism of the first example;

FIG. 6 is an explanatory view schematically illustrating the operation of the knob and the rotor in the lock mechanism of the first example;

FIG. 7 is an explanatory diagram schematically illustrating the operation of the knob and the rotor in the lock mechanism of the first example;

FIG. 8 is an explanatory diagram schematically illustrating changes in the operation of the knob and the rotor in the lock mechanism of the first example;

FIG. 9 is an explanatory diagram illustrating a knob and a rotor in a lock mechanism according to a second example; and

FIG. 10 is an explanatory diagram illustrating the knob and the rotor in the lock mechanism according to the second example.

### DETAILED DESCRIPTION OF THE INVENTION

A rotor in a lock mechanism of the invention is a rotary type rotor which rotates between a lock input position and a release input position about the rotor rotation axis. The knob is also a rotary type knob which rotates between a normal position and a release operation position around the rotation shaft.

In the lock mechanism of the invention, during an opening operation in which the knob rotates from the normal position to the release operation position, a pressing portion of the knob slides on a pressure receiving surface of the rotor and presses the pressure receiving surface to rotate the rotor from the lock input position to the release input position.

Here, a pair of rods are connected to the rotor. Then, a locking portion having the pair of rods changes its state between a locked state and a released state with the rotation of the rotor between the lock input position and the release input position. Therefore, when the rotor rotates from the lock input position to the release input position during the above-described opening operation, the state of the locking portion changes from the locked state to the released state. When the state of the locking portion becomes the released state, the lock of an object by the lock mechanism is released.

In the lock mechanism of the invention, the pressing portion of the knob presses the pressure receiving surface of the rotor while sliding on the pressure receiving surface. Therefore, when the pressing portion slides on the pressure receiving surface, the torque generated by the rotation of the knob is smoothly transmitted to the pressure receiving surface. In other words, the lock mechanism of the invention does not require an excessive force to operate the knob.

Further, in the lock mechanism of the invention, the relationship between the following (A) and (B) satisfies “(A)≥0.8×(B)”.

(A) Length obtained by projecting a sliding locus of the pressing portion on the pressure receiving surface on a cross-section in an axial perpendicular direction of the rotor.

(B) Length by which the position of the pressing portion has actually changed.

When (A) and (B) have the above relationship, it can be said that most of the position change of the pressing portion is spent on the sliding on the pressure receiving surface and most of the sliding can contribute to the rotation of the rotor. Therefore, according to the lock mechanism of the invention in which the relationship between (A) and (B) satisfies “(A)≥□0.8×(B)”, the operation of the knob does not require an excessive force and the force generated by the operation of the knob can be converted into the rotation of the rotor without loss.

Therefore, in the lock mechanism of the invention, it can be said that the rotor can be rotated sufficiently even when, for example, the rotation angle of the knob is small, and thus it can be said that such a lock mechanism of the invention has excellent operability.

The relation between (A) and (B) may satisfy “(A)≥0.8×(B)”. However, it can be said that the closer the value of (A) is to the value of (B), the more the force generated by operating the knob is transmitted to the rotor without loss. Therefore, “(A)≥0.9×(B)”. “(A)≥0.95×(B)”, and “(A)=(B)” can be cited as more preferable relationships between (A) and (B).

The length of (A) described above is not the actual size of the sliding locus of the pressing portion on the pressure receiving surface, but the length of the sliding locus projected on the cross-section in the axial perpendicular direction of the rotor. Therefore, the pressing portion in the lock mechanism of the invention may or may not change its position in the axial direction of the rotor when sliding on the pressure receiving surface of the rotor. When the pressing portion slides on the pressure receiving surface without changing its position in the axial direction of the rotor, the relationship between (A) and (B) can be approximated to “(A)=(B)”. Therefore, the force generated by the operating the knob can be transmitted to the rotor with less loss.

Further, although the pressing portion of the knob in the lock mechanism of the invention slides on the pressure receiving surface of the rotor, the pressing portion and the pressure receiving surface may slide relative to each other. That is, the abutment position of the pressing portion with the pressure receiving surface of the rotor may be a specific point or may gradually change according to the rotation of the knob. In this case, regarding (B) described above, the contact point with the pressure receiving surface of the pressing portion is set for each rotation angle of the knob and the length of the line connecting the obtained plurality of contact points may be regarded as “the length of the actual position change of the pressing portion”.

Hereinafter, the lock mechanism of the invention will be described for each component.

The lock mechanism of the invention is not limited to the side lock mechanism of the glove box described above and can be used to lock various objects.

The lock mechanism of the invention includes the rotor, the knob, the locking portion, a rotor urging member, and a knob urging member.

The rotor has a rotor rotation axis, the pressure receiving surface, and a pair of rod connecting portions and rotates about the rotor rotation axis. The rotor rotation axis means the rotation center of the rotor and its shape is not particularly limited. For example, the rotor rotation axis may actually have a shaft shape or a hole shape. The pressure receiving surface and the rod connecting portion are radially outside the rotor rotation axis. Therefore, the rotation of the rotor and the position change of the pressure receiving surface and the rod connecting portion are interlocked with each other.

The rod connecting portion may be a portion connected to the rod and its connecting method is not particularly limited. For example, it may be directly connected to the rod by a method of pivotally supporting the rod. Alternatively, the rod connecting portion may be connected to the rod by a method such as meshing with a gear provided on the rod or frictionally engaging with a sliding contact surface provided on the rod.

The position of the pair of rod connecting portions in the rotor may be appropriately set according to the rotation angle of the rotor, the length of each rod, the amount of positional change of each rod, and the like.

The pressure receiving surface is a surface with which the pressing portion of the knob is in sliding contact. The pressure receiving surface may have a shape capable of receiving a pressing force from the pressing portion of the knob and applying a force in the rotation direction to the rotor. Such a shape of the pressure receiving surface may be rephrased as a shape in which the distance from the rotor rotation axis gradually changes in the cross-section in the axial perpendicular direction of the rotor.

In addition, in this specification, the “axial perpendicular direction” means the direction orthogonal to the axial direction.

In a cross-section in the axial perpendicular direction of the rotor, one end of the pressure receiving surface on the side far from the rotor rotation axis is a first end and the other end is a second end. The distance between the second end and the rotor rotation axis is shorter than the distance between the first end and the rotor rotation axis. Then, it can be said that the pressure receiving surface is continuous between the first end portion and the second end portion and extends in the direction approaching the rotor rotation axis from the first end toward the second end. Such a pressure receiving surface may be a flat surface or a curved surface.

The knob has a knob rotation axis and a pressing portion and rotates about the knob rotation axis. The knob rotation axis means the rotation center of the knob, similarly to the rotor rotation axis described above and the shape thereof is not particularly limited.

The pressing portion is radially outside the knob rotation axis. Therefore, the rotation of the knob and the position change of the pressing portion are interlocked with each other.

The knob rotates between a normal position and a release operation position. During the opening operation in which the knob rotates from the normal position to the release operation position, the pressing portion of the knob slides on the pressure receiving surface of the rotor and presses the pressure receiving surface to rotate the rotor from the lock input position to the release input position. Therefore, it can be said that the pressing portion of the knob abuts on the first end of the pressure receiving surface at the initial stage of the opening operation, and then the pressing portion slides on the pressure receiving surface toward the second end.

The rotating shaft of the knob which operates in this manner, that is, the knob rotation axis may extend in a direction intersecting with the rotor rotation axis.

As described above, in the cross-section in the axial perpendicular direction of the rotor, the pressure receiving surface extends from the first end toward the second end in a direction approaching the rotor rotation axis. Therefore, it can be said that the pressing portion approaches the rotor rotation axis when sliding on the pressure receiving surface from the first end toward the second end during the opening operation. In addition, when the distance between the pressing portion and the rotor rotation axis is short, it is possible to increase the rotation angle of the rotor with respect to the sliding length of the pressing portion as compared with the case where the distance between the pressing portion and the rotor rotation axis is long. In other words, when the distance between the pressing portion and the rotor rotation axis is short, it is possible to rotate the rotor largely with a small movement of the pressing portion.

When the pressing portion approaches the rotor rotation axis during the opening operation, the rotation angle of the rotor per unit sliding length of the pressing portion increases and the position change amount of the rod of the locking portion also increases accordingly. In this case, especially at the final stage of the opening operation in which the pressing portion is near the rotor rotation axis, the positional change amount of the rod per unit sliding length of the pressing portion becomes extremely large. By sufficiently changing the position of the rod at the final stage of the opening operation, the lock of the object represented by the glove box is released with high reliability.

Here, when the pressing portion suddenly approaches the rotor rotation axis during the opening operation, the rotation angle of the rotor per unit sliding length of the pressing portion suddenly increases and the load of the knob also suddenly increases. As a result, the user's operational feeling may be impaired. However, when the pressure receiving surface is a curved surface, particularly an arc surface having a constant curvature, the load acting on the knob linearly increases from the initial stage to the final stage of the opening operation. Therefore, in this case, the operation feeling of the user who operates the knob is not impaired.

Therefore, it can be said that the pressure receiving portion preferably has a curved surface shape, and more preferably has an arc surface shape with a constant curvature.

In the lock mechanism of the invention, the pressing portion changes its position as the knob rotates about the knob rotation axis. The pressing portion may change its position in any direction as long as it can slide the pressure receiving surface and rotate the rotor during the opening operation. However, considering that the rotor is largely rotated at the final stage of the opening operation as described above, it is preferable that the position of the pressing portion be changed in the direction in which the distance from the rotor rotation axis becomes shorter during the opening operation. In other words, it is preferable that the position of the pressing portion changes toward the rotor rotation axis during the opening operation.

Since the knob rotation axis extends in the direction intersecting with the rotor rotation axis as described above, the locus of the position change of the pressing portion becomes a straight line when projected on the cross-section in the axial perpendicular direction of the rotor. In order to change the position of the pressing portion toward the rotor rotation axis during the opening operation, the straight line preferably passes through the rotor rotation axis.

The direction of the rotation shaft of the knob is not particularly limited. For example, when the lock mechanism of the invention is a side lock mechanism of a glove box and the rod locks with lock receiving portions provided on both sides of the glove box, the rotating shaft of the knob may extend in a direction in which the two lock receiving portions are connected, that is, in a direction parallel to a moving direction of the rod, or may extend in a direction intersecting with the moving direction of the rod.

The locking portion has a pair of rods. One of the rods is connected to one of the rod connecting portions of the rotor and the other of the rods is connected to the other of the rod connecting portions. As the rotor rotates, each rod connected to the rotor also changes position. It can be said that the change in the position of the rod changes the state of the locking portion. That is, the locking portion changes its state between the locked state and the released state due to the change in the position of the rod due to the rotation between the lock input position and the release input position of the rotor. In the side lock mechanism described above, each rod engages with the corresponding lock receiving portion in the locked state and the lock between each rod and the lock receiving portion is released in the released state.

The pair of rods may have the same shape or different shapes. Further, the manner of changing the position of the rod described above is not particularly limited. For example, the locking portion may change the state by sliding the rod or the locking portion may change the state by rotating the rod. Needless to say, the state of the locking portion may change as the rod slides and rotates.

The rotor urging member urges the rotor to the lock input position. The locking portion is also urged to the locked state by urging the rotor to the lock input position by the rotor urging member. Therefore, the lock of the object by the locking portion is stably maintained.

The rotor urging member may be any member which can urge the rotor to the lock input position. As such a rotor urging member, for example, a known urging member such as a torsion coil spring or a spiral spring may be used. The rotor urging member may be attached to the rotor or may be attached to the locking portion. This is because the rotor can be indirectly urged by urging the locking portion.

The knob urging member urges the knob to the normal position. During the opening operation described above, the knob rotates from the normal position to the release operation position, but thereafter, the knob is returned to the normal position by the knob urging member, and can be rotated again toward the release operation position.

The knob urging member may be any member which can urge the knob to the normal position and a known urging member such as a torsion coil spring or a spiral spring may be used as in the rotor urging member described above.

Hereinafter, the lock mechanism of the invention will be described with reference to specific examples.

The lock mechanism of a first example is a side lock mechanism of a glove box.

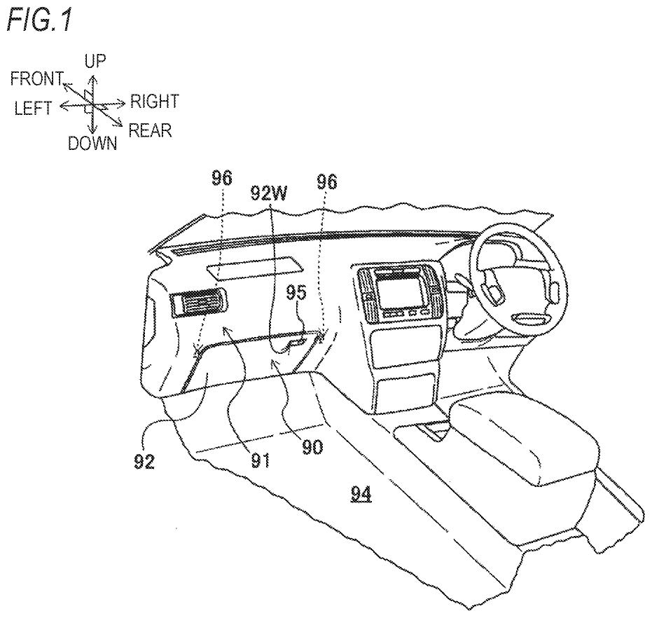

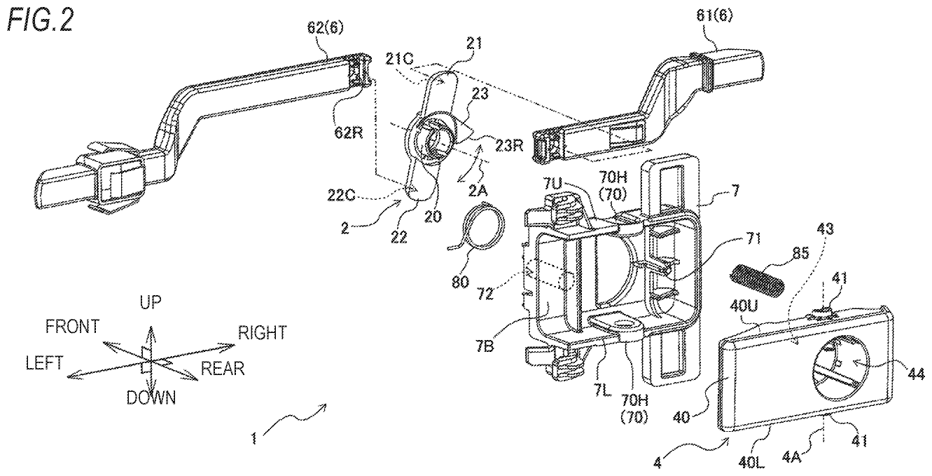

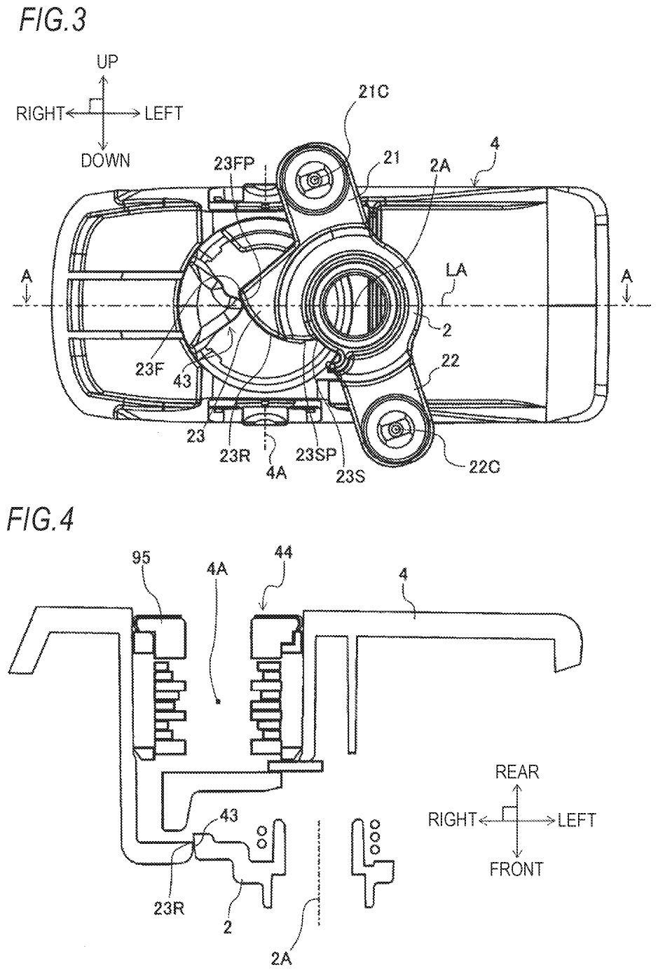

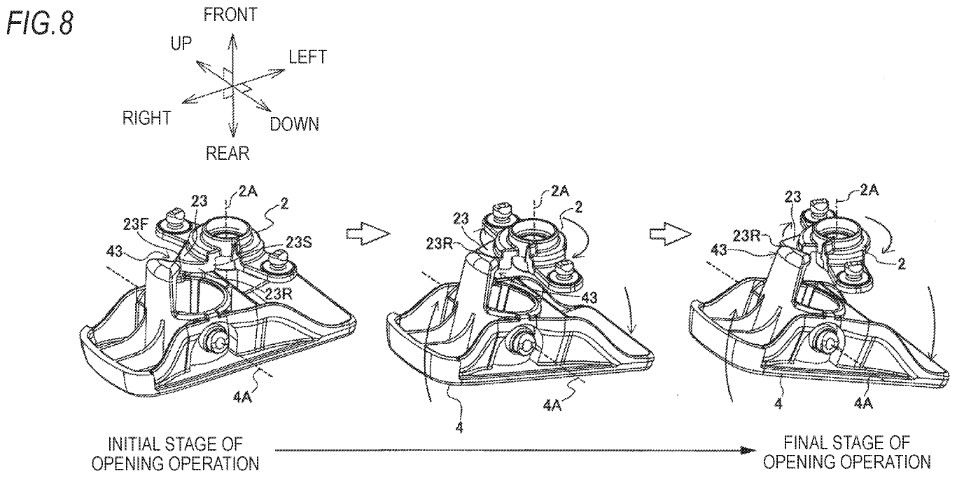

FIG. 1 is an explanatory diagram schematically illustrating a lock mechanism of the first example mounted on a vehicle and a glove box including the lock mechanism. FIG. 2 is an explanatory view schematically illustrating a disassembled state of the lock mechanism of the first example. FIGS. 3 to 7 are explanatory views schematically illustrating operation of a knob and a rotor in the lock mechanism of the first example. FIG. 8 is an explanatory diagram schematically illustrating changes in the operation of the knob and the rotor in the lock mechanism of the first example.

Hereinafter, upper, lower, left, right, front, and rear shall mean upper, lower, left, right, front, and rear illustrated in FIGS. 1 and 2.

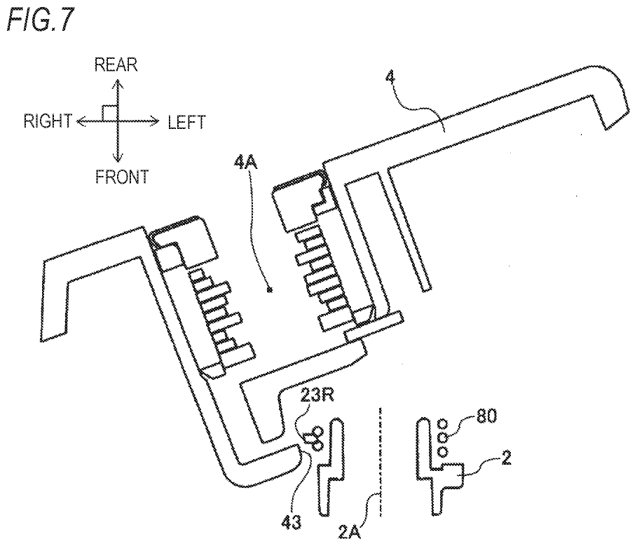

FIGS. 3, 5, and 6 illustrate the lock mechanism of the first example as viewed from the front side and FIGS. 4 and 7 illustrate the lock mechanism of the first example as viewed from the upper side. Since the rotor rotation shaft extends in a front-rear direction, the positional relationship between the elements in FIGS. 3, 5, and 6 is the same as the positional relationship between the elements in a cross-section in the axial perpendicular direction of the rotor.

Therefore, hereinafter, FIGS. 3, 5, and 6 may be regarded as views illustrating a cross-section in the axial perpendicular of the rotor, if necessary.

In FIG. 2, each element forming the lock mechanism of the first example is arranged in the same manner as when the knob in the lock mechanism is in the normal position and the rotor is in the lock input position.

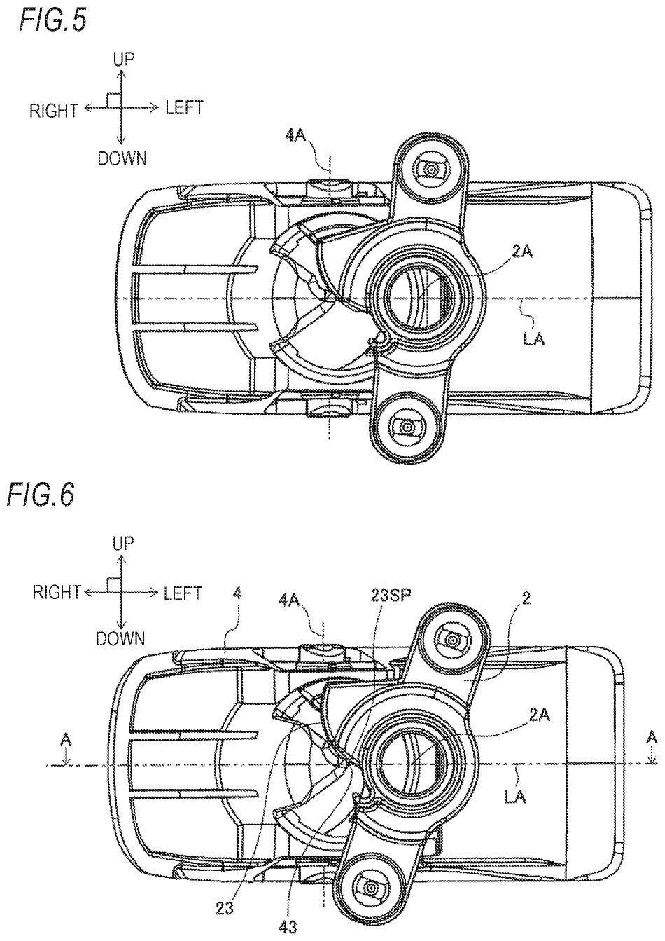

Furthermore, FIG. 3 represents the lock mechanism of the example 1 in which the knob is in the normal position and the rotor is in the lock input position. Further, FIG. 6 illustrates the lock mechanism of the first example in which the knob is in the release operation position and the rotor is in the release input position. FIG. 5 illustrates the lock mechanism of the first example in which the knob is in a knob predetermined position between the normal position and the release operation position and the rotor is in a rotor predetermined position between the lock input position and the release input position. FIG. 4 illustrates a state where the lock mechanism of the first example in which the knob is in the normal position and the rotor is in the lock input position as illustrated in FIG. 3 is cut at the A-A position. FIG. 7 illustrates a state in which the lock mechanism of the first example in Which the knob is in the release operation position and the rotor is in the release input position as illustrated in FIG. 6 is cut at the A-A position.

As illustrated in FIG. 1, a glove box 90 equipped with the lock mechanism of the first example is attached to an instrument panel 91 of a vehicle. A lid 92 of the glove box 90 is exposed in a vehicle interior 94. In a closed position illustrated in FIG. 1, the front surface of the lid 92 faces the rear side and the rear surface thereof faces the front side.

A lock mechanism 1 of the first example includes a rotor 2, a knob 4, a locking portion 6, a base 7, a rotor urging member 80, and a knob urging member 85 illustrated in FIG. 2.

The rotor 2, the knob 4, the locking portion 6, the rotor urging member 80, and the knob urging member 85 are all directly or indirectly attached to the base 7. The base 7 is attached to the front surface (that is, the hack surface) of the lid 92 of the glove box 90. As illustrated in FIG. 1, the lid 92 is provided with a window portion 92W and the knob 4 attached to the rear surface of the base 7 is exposed to the rear surface (that is, the front surface) of the lid 92 through the window portion 92W.

As illustrated in FIG. 2, the base 7 has a substantially box-like shape which closes to the rear and has a knob shaft support portion 70, an urge support portion 71, and a rotor shaft support portion 72.

The knob shaft support portion 70 has a pair of knob shaft support holes 70H arranged in the up-down direction. One knob shaft support hole 70H vertically penetrates an upper wall 7U of the base 7. The other knob shaft support hole 70H vertically penetrates a lower wall 7L of the base 7.

The urge support portion 71 has a rib shape protruding rearward from the rear surface of a bottom wall 7B of the base 7. The knob urging member 85 having a spiral spring shape is attached to the urge support portion 71.

The rotor shaft support portion 72 has a shaft shape protruding forward from the front surface of the bottom wall 7B of the base 7.

The rotor 2 has a substantially cylindrical rotor shaft hole portion 20, and a substantially plate-shaped first arm portion 21, a second arm portion 22, and a pressure receiving portion 23 which extend in the axial perpendicular direction with respect to the rotor shaft hole portion 20.

The first arm portion 21 and the second arm portion 22 have a long shape and the pressure receiving portion 23 has a substantially fan shape having an arc surface.

The first arm portion 21 has its protruding end portion directed substantially upward. The second arm portion 22 has its protruding end portion directed substantially downward.

A shaft-shaped first rod connecting portion 21C protruding forward is provided at a protruding end portion of the first arm portion 21. A shaft-shaped second rod connecting portion 22C protruding forward is provided at a protruding end portion of the second arm portion 22. The first rod connecting portion 21C and the second rod connecting portion 22C correspond to the rod connecting portions in the lock mechanism 1 of the invention.

By mounting the rotor shaft hole portion 20 on the rotor shaft support portion 72 of the base 7, the rotor 2 is supported by the base 7. The axis of the rotor shaft hole portion 20 serves as the center of rotation of the rotor 2, that is, a rotor rotation axis 2A.

A rotor urging member 80 is attached to the rotor shaft hole portion 20. The rotor urging member 80 has a torsion coil spring shape and one end thereof is fixed to the rotor shaft hole portion 20. The other end of the rotor urging member 80 is fixed to the base 7.

The pressure receiving portion 23 has its arc surface facing rightward and downward. The arc surface of the pressure receiving portion 23 corresponds to a pressure receiving surface 23R in the lock mechanism 1 of the invention. As illustrated in FIG. 3, a first end 23F, which is one end of the pressure receiving surface 23R, is farther from the rotor rotation axis 2A than a second end 23S, which is the other end. Therefore, the pressure receiving surface 23R extends from the first end portion 23F toward the second end portion 23S in a direction approaching the rotor rotation shaft 2A. The curvature of the pressure receiving surface 23R, which is an arc surface, is substantially constant at each position of the pressure receiving surface 23R.

As illustrated in FIG. 2, the knob 4 has an operation lever 40, a pair of knob shaft portions 41, a pressing portion 43, and a cylinder mounting portion 44.

The operation lever 40 has a long, substantially plate-like shape, and the longitudinal direction thereof is parallel to a left-right.

Each knob shaft portion 41 has a shaft shape. One knob shaft portion 41 extends upward from an upper wall 40U of the operation lever 40. One knob shaft portion 41 extends downward from a lower wall 40L of the operation lever 40. By inserting each knob shaft portion 41 into the corresponding knob shaft support portion 70, the knob 4 is pivotally supported by the base 7. The axis of the knob shall portion 41 is the rotation center of the knob 4, that is, a knob rotation axis 4A.

The knob shaft portion 41 is arranged slightly to the right of the center line in the longitudinal direction of the operation lever 40. Since the rotor shaft support portion 72 of the base 7 is located further on the left side than the knob shaft support portion 70, when mounted on the base 7, the knob 4 is supported slightly to the right than the rotor 2.

The pressing portion 43 protrudes from the front surface of the operation lever 40 toward the front. As illustrated in FIG. 3, the pressing portion 43 has a pointed shape and the pointed portion is directed to the left.

In the lock mechanism 1 of the first example, when the knob 4 rotates about the knob rotation axis 4A, as illustrated in FIGS. 3, 5, and 6, the pressing portion 43 of the knob 4 changes its position on a straight line LA passing through the rotor rotation axis 2A in the cross-section in the axial perpendicular direction of the rotor rotation axis 2A.

As illustrated in FIG. 2, the knob urging member 85 is attached to the urge support portion 71 of the base 7. The rear end of the knob urging member 85 abuts on an urging receiving portion (not illustrated) provided on the front surface of the operation lever 40. Therefore, the knob urging member 85 is interposed between the knob 4 and the base 7. An urge receiving portion is located further on the right side than the knob rotation axis 4A. When a user pulls the left end of the operation lever 40 rearward, the knob 4 rotates about the knob rotation axis 4A and the knob urging member 85 is pressed forward by the urge receiving portion. Therefore, in this case, the knob urging member 85 compresses and accumulates the biasing force. Due to the urging force, the knob urging member 85 urges the knob 4 to the normal position illustrated in FIG. 2.

The locking portion 6 has a first rod 61 and a second rod 62. The first rod 61 and the second rod 62 have a rod shape extending substantially in the left-right direction and the length of the second rod 62 in the longitudinal direction is longer than the length of the first rod 61 in the longitudinal direction. The second rod 62 is arranged on the left side of the first rod 61.

At the left end of the first rod 61, a through-hole-shaped first connection receiving portion 61R is provided. The first connection receiving portion 61R pivotally supports the first rod connecting portion 21C. Further, a right end of the second rod 62 is provided with a through-hole-shaped second connection receiving portion 62R. The second connection receiving portion 62R pivotally supports the second rod connecting portion 22C. Therefore, the first rod 61 is connected to the first rod connecting portion 21C of the rotor 2 and the second rod 62 is connected to the second rod connecting portion 22C of the rotor 2.

Although not illustrated, the lid 92 is provided with a guide portion which guides the first rod 61 and the second rod 62. In a state where the first rod 61 and the second rod 62 are guided by the guide portion, the first rod 61 and the second rod 62 slide left and right while slightly rotating or tilting with respect to the lid 92.

Furthermore, the operation lever 40 is provided with the cylinder mounting portion 44. The cylinder mounting portion 44 has a substantially cylindrical shape which penetrates in the front-rear direction. A key cylinder 95 (FIG. 4) is mounted on the cylinder mounting portion 44. Although details are omitted, it is possible to regulate the rotation of the knob 4 by inserting a key into the key cylinder 95 and rotating the key.

The operation of the lock mechanism 1 of the first example will be described below.

When the lid 92 is in the closed position illustrated in FIG. 1, the knob 4 of the lock mechanism 1 is urged by the knob urging member 85 and is in the normal position illustrated in FIGS. 2, 3, and 4. The rotor 2 is biased by the rotor urging member 80 and is in the lock input position illustrated in FIGS. 2, 3, and 4.

In this case, the rotor 2 is urged clockwise in FIG. 2. Therefore, the first rod 61 is pressed to the right by the first rod connecting portion 21C of the rotor 2 and the second rod 62 is pressed to the left by the second rod connecting portion 22C of the rotor 2. The locking portion 6 is in a locked state in which the tip of the first rod 61 protrudes to the right of the lid 92 and the tip of the second rod 62 protrudes to the left of the lid 92. The tip of the first rod 61 and the tip of the second rod 62 are respectively engaged with the lock receiving portions 96 provided on the left and right sides of the lid 92 in the instrument panel 91. Thus, the lid 92 is locked in the closed position by the lock mechanism 1.

In this case, as illustrated in FIGS. 3 and 4, the pressing portion 43 of the knob 4 abuts on the pressure receiving surface 23R of the rotor 2 on the first end 23F side.

When a user pulls the left side of the operation lever 40 of the knob 4 to the rear side, the knob 4 rotates around the knob rotation axis 4A and its left end is directed rearward (the direction toward the back of the paper in FIG. 3) and its right end is directed toward the front (the front of the paper in FIG. 3).

Then, the pressing portion 43 of the knob 4 pushes the pressure receiving surface 23R of the rotor 2 from the right side to the left side. As described above, the pressing portion 43 of the knob 4 changes its position on the straight line LA passing through the rotor rotation axis 2A in the cross-section in the axial perpendicular direction of the rotor rotation axis 2A. Therefore, in this case, it can be said that the knob 4 presses the pressure receiving surface 23R of the rotor 2 toward the rotor rotation axis 2A.

The pressure receiving surface 23R of the rotor 2 is inclined in a direction approaching the rotor rotation axis 2A from the first end 23F side toward the second end 23S side. Therefore, the rotor 2 whose the pressure receiving surface 23R is pressed by the pressing portion 43 rotates clockwise in FIG. 3 (counterclockwise in FIG. 2). In this case, the pressing portion 43 slides on the pressure receiving surface 23R from the first end 23F side to the second end 23S side, as illustrated in FIGS. 3, 5, and 6.

When the rotor 2 rotates clockwise in FIG. 3, that is, counterclockwise in FIG. 2, the position of the first rod connecting portion 21C of the rotor 2 changes to the left and the position of the second rod connecting portion 22C changes to the right. Therefore, the position of the first rod 61 illustrated in FIG. 2 changes to the left and the position of the second rod 62 changes to the right. Therefore, the locking portion 6 changes its state to the released state in which the tip of the first rod 61 and the tip of the second rod 62 are drawn inside the lid 92. As a result, the lock of the tip of the first rod 61 and the tip of the second lid 62 and the lock receiving portions 96 illustrated in FIG. 1 is released and the lock of the lid 92 by the lock mechanism 1 is released.

The locking between the locking portion 6 and the lock receiving portion 96 in the lock mechanism 1 of the first example is actually released when the locking portion 6 changes its state to a predetermined state between the locked state and the released state illustrated in FIG. 5. That is, the knob 4 rotates from the normal position illustrated in FIG. 3 to the release operation position illustrated in FIG. 6 and the rotor 2 rotates from the lock input position illustrated in FIG. 3 to the release input position illustrated in FIG. 6. As a result, the locking portion 6 changes its state from the locked state illustrated in FIG. 3 to the released state illustrated in FIG. 6. However, before each of those elements reaches the state illustrated in FIG. 6, the first rod 61 and the second rod 62 of the locking portion 6 are detached from the lock receiving portions 96. In other words, in the lock mechanism 1 of the first example, even after the locking by the locking portion 6 is released, the knob 4, the rotor 2, and the locking portion 6 change in position or change in state by a predetermined amount. In this manner, in the lock mechanism 1 of the first example, the locking portion 6 can reliably change its state to the released state.

As illustrated in FIG. 8, when the lock mechanism 1 of the first example is opened, the pressing portion 43 changes its position on an arc centered on the knob rotation axis 4A from the initial stage of the opening operation to the final stage of the opening operation. In this case, the pressing portion 43 slides on the pressure receiving surface 23R with respect to the rotor 2 from the first end 23F to the second end 23S. More specifically, the pressing portion 43 slides on the pressure receiving surface 23R from a first abutment point 23FP illustrated in FIG. 3 to a second abutment point 23SP illustrated in FIGS. 3 and 6.

As illustrated in FIG. 3, on the cross-section in the axial perpendicular direction of the rotor 2, the sliding locus of the pressing portion 43 on the pressure receiving surface 23R is a section from the first abutment point 23FP to the second abutment point 23SP in the curve obtained by cutting the pressure receiving surface 23R in the axial direction.

Here, in the lock mechanism 1 of the first example, the abutment position of the pressing portion 43 with the pressure receiving surface 23R also gradually changes during the opening operation. Therefore, it can be said that, in the lock mechanism 1 of the first example, the pressure receiving portion 23 and the pressing portion 43 slide relative to each other. Therefore, although the pressing portion 43 changes its position in the direction intersecting the axial direction of the rotor rotation axis 2A as the knob 4 rotates, the abutment position of the pressing portion 43 with the pressure receiving surface 23R is substantially fixed on the cross-section in the axial perpendicular direction of the rotor 2.

Therefore, in the lock mechanism 1 of the first example,

(A) The length (that is, a length from the first abutment point 23FP to the second abutment point 23SP of the pressure receiving surface 23R illustrated in FIG. 3) obtained by projecting the sliding locus of the pressing portion 43 on the pressure receiving surface 23R on the cross-section in the axial perpendicular direction of the rotor 2 and

(B) The length by which the position of the pressing portion 43 has actually changed satisfy substantially the relationship of “(A)=(B)”.

That is, in the lock mechanism 1 of the first example, the pressing portion 43 of the knob 4 presses the pressure receiving surface 23R of the rotor 2 in almost the entire section in which the knob 4 rotates, thereby rotating the rotor 2. Therefore, according to the lock mechanism 1 of the first embodiment, the rotation of the knob 4 is converted into the rotation of the rotor 2 without any loss, so that the rotor 2 can be efficiently rotated and the state of the locking portion 6 can be efficiently changed.

Further, since the pressing portion 43 of the knob 4 slides on the pressure receiving surface 23R of the rotor 2, it does not require an excessive force to operate the knob 4.

Further, in the lock mechanism 1 of the first example, the pressing portion 43 changes its position toward the rotor rotation axis 2A during the opening operation. In particular, the pressing portion 43 in the first example changes its position on the straight line LA passing through the rotor rotation axis 2A in the axial perpendicular cross-section of the rotor rotation axis 2A. Therefore, the distance between the pressing portion 43 of the knob 4 and the rotor rotation axis 2A becomes shorter from the initial stage of the opening operation to the final stage of the opening operation, as illustrated in FIGS. 3, 5, and 6. Therefore, the position change amount of the rotor 2 with respect to the position change amount of the pressing portion 43, that is, the rotation angle of the rotor 2 with respect to the rotation angle of the knob 4, is relatively small in the initial stage of the opening operation and relatively large in the final stage of the opening operation.

Therefore, according to the lock mechanism I of the first example, the locking portion 6 can be operated firmly until it reaches the released state, and thus the opening operation unlocks the glove box 90 reliably.

With the above cooperation, the lock mechanism 1 of the first example is excellent in operability.

Also, as described above, in the lock mechanism 1 of the first example, since the pressing portion 43 of the knob 4 changes its position toward the rotor rotation axis 2A during the opening operation, the rotor 2 largely rotates at the final stage of the opening operation. However, the pressure receiving surface 23R of the rotor 2 in the lock mechanism 1 of the first example is an arc surface. In particular, the curvature of the pressure receiving surface 23R is constant in the section from the first abutment point 23FP to the second abutment point 23SP. As a result, in the lock mechanism 1 of the first example, the load acting on the knob 4 increases linearly from the initial stage to the final stage of the opening operation. Therefore, in the lock mechanism 1 of the first example, there is no problem such as a sudden increase in the operating load, and it can be said that the lock mechanism 1 of the first example is excellent in operation feeling.

A lock mechanism of a second example is substantially the same as the lock mechanism of the first example except for the shape of the knob, the shape of the rotor, and the positional relationship between the pressing portion and the pressure receiving surface.

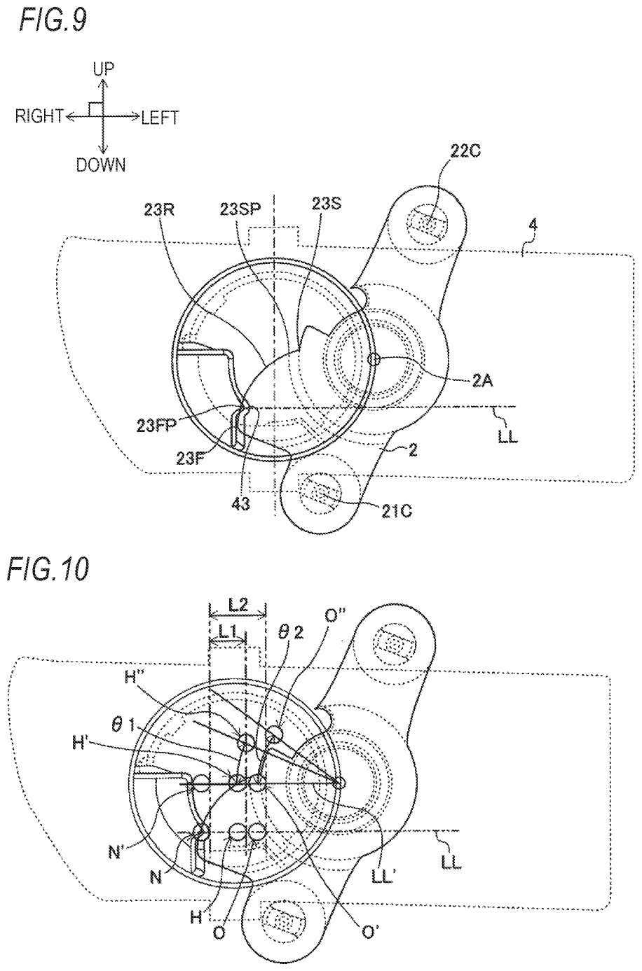

FIGS. 9 and 10 are explanatory views for explaining the knob and the rotor in the lock mechanism of the second example. FIGS. 9 and 10 illustrate the lock mechanism of the second example as seen from the front side, as in FIGS. 3, 5, and 6 of the first example. Since the positional relationship of each element in FIGS. 9 and 10 is the same as the positional relationship of each element in the cross-section in the axial perpendicular direction of the rotor, as in FIGS. 3, 5, and 6. Therefore, also in the second example, if necessary, FIGS. 9 and 10 are regarded as views illustrating the cross-section in the axial perpendicular direction of the rotor.

As illustrated in FIG. 9, in the lock mechanism 1 of the second example, the pressing portion 43 of the knob 4 has its tip pointed to the left. The pressure receiving surface 23R of the rotor 2 is located on the right side and below the rotor rotation axis 2A and the first end 23F is located on the right side and below the second end 23S.

In the normal position of the knob 4 illustrated in FIG. 9, the first rod connecting portion 21C of the rotor 2 faces the lower side and the right side and the second rod connecting portion 22C faces the upper side and the left side. Similar to the first example, the first rod connecting portion 21C is connected to the first connection receiving portion 61R of the first rod 61 and the second rod connecting portion 22C is connected to the second connection receiving portion 62R of the second rod 62.

The pressing portion 43 of the lock mechanism 1 of the second embodiment, like the pressing portion 43 of the lock mechanism 1 of the first example, abuts on the first abutment point 23FP on the pressure receiving surface 23R at the normal position of the knob 4. Although not illustrated, at the release operation position of the knob 4, the pressing portion 43 abuts on the second abutment point 23SP on the pressure receiving surface 23R.

Also, in the lock mechanism 1 of the second example,

(A) The length (that is, a length from the first abutment point 23FP to the second abutment point 23SP of the pressure receiving surface 23R illustrated in FIG. 9) obtained by projecting the sliding locus of the pressing portion 43 on the pressure receiving surface 23R on the cross-section in the axial perpendicular direction of the rotor 2 and

(B) The length by which the position of the pressing portion 43 has actually changed satisfy substantially the relationship of “(A)=(B)”.

In the lock mechanism 1 of the second example, the shapes of the knob 4 and the rotor 2 are different from those of the lock mechanism 1 of the first example. However, similar to the lock mechanism 1 of the first example, during the opening operation, the pressing portion 43 of the knob 4 slides on the pressure receiving surface 23R and presses the pressure receiving surface 23R.

Also, the relationship between (A) and (B) described above is approximately (A) (B).

For this reason, it can be said that the lock mechanism 1 of the second example has excellent operability like the lock mechanism 1 of the first example.

Also in the lock mechanism 1 of the second example, similar to the lock mechanism 1 of the first example, the pressure receiving surface 23R has an arc surface shape with a constant curvature. For this reason, the lock mechanism 1 of the second example is also excellent in operation feeling.

It is considered that the curvature of the pressure receiving surface 23R having an arc surface shape should be designed in consideration of the rotation angle of the knob 4 and the rotation angle of the rotor 2. This is because the rotation angle of the knob 4 may be set in an appropriate range according the shape and size of the knob 4 and the rotation angle of the rotor 2 may also be set in an appropriate range according to the positional change amount of the first rod 61 and the second rod 62 which follow the rotor 2.

The movement locus of the pressing portion 43 of the knob 4 is determined according to the shape of the knob 4 and the rotation angle of the knob 4. When the movement locus of the pressing portion 43 is projected on the cross-section in the axial perpendicular direction of the rotor 2 in the lock mechanism 1 of the second example, as illustrated in FIG. 10, the movement locus passes on a straight line LL below the rotor rotation axis 2A.

On the movement locus, when the position of the pressing portion 43 when the knob 4 is in the normal position is set to N and the position of the pressing portion 43 when the knob 4 is in the release operation position is set to O, and further the position of the pressing portion 43 when the knob 4 is in the knob predetermined position between the normal position and the release operation position is set to H, it can be said that the pressing portion 43 moves in the order of N, H, and O on the movement locus. Further, on the straight line LL, the movement amount of the pressing portion 43 from the normal position to the knob predetermined position is L1 in FIG. 10 and the movement amount of the pressing portion 43 from the normal position to the release operation position is L2 in FIG. 10.

Here, the rotor 2 is in the lock input position when the knob 4 is in the normal position. The rotor 2 is in the release input position when the knob 4 is in the release position. Also, when the knob 4 is in the above-described knob predetermined position, the rotor 2 is in the rotor predetermined position between the lock input position and the release input position.

When the pressing portion 43 changes its position on the straight line LL in FIG. 10 from N to H by a length L1, it can be said that the rotor 2 rotates from the lock input position to the rotor predetermined position by a rotation angle θ1. Further, when the pressing portion 43 changes its position on the straight line LL in FIG. 10 from N to O by a length L2, it can be said that the rotor 2 rotates from the lock input position to the release input position by a rotation angle θ2.

The straight line LL and the positions N, H, and O of the pressing portion 43 described above are slid upward toward the rotor rotation axis 2A to obtain the straight line LL passing through the rotor rotation axis 2A and the positions N′, H′, and O′ of the pressing portion 43 corresponding thereto.

Then, the above H′ is rotated about the rotor rotation axis 2A from the lock input position to the rotor predetermined position by the rotation angle θ1 of the rotor 2 to obtain H″. Further, the above O′ is rotated about the rotor rotation axis 2A from the lock input position to the release input position by the rotation angle θ2 of the rotor 2 to obtain O″.

N′, H″, and O″ are smoothly connected with a curve and a curved surface including the curve is set as the pressure receiving surface 23R of the rotor 2.

The pressure receiving surface 23R in the lock mechanism 1 of the second example designed by the method described above can rotate the rotor 2 at a sufficient angle according to the amount of state change required for the locking portion 6 according to the amount of rotation of the knob 4.

Although not specifically described, the pressure receiving surface 23R in the lock mechanism 1 of the first embodiment is also designed by the similar method.

The invention is not limited to the embodiments described above and illustrated in the drawings and can be implemented with appropriate modifications without departing from the scope of the invention. Moreover, each component shown in this specification including embodiments can be extracted arbitrarily and combined and implemented.

What is claimed is:

1. A lock mechanism, comprising:
a rotor including a rotor rotation axis, a pair of rod connecting portions located radially outside of the rotor rotation axis, and a pressure receiving surface located radially outside of the rotor rotation axis, the rotor configured to rotate between a lock input position and a release input position around the rotor rotation axis;
a knob including a knob rotation axis and a pressing portion located radially outside of the knob rotation axis, the knob configured to rotate between a normal position and a release operation position around the knob rotation axis;
a locking portion including a pair of rods respectively connected to one and the other of the pair of rod connecting portions, the locking portion configured to change its state between a locked state and a released state with rotation of the rotor between the lock input position and the release input position;
a rotor urging member configured to urge the rotor to the lock input position; and
a knob urging member configured to urge the knob to the normal position, wherein
during an opening operation in which the knob rotates from the normal position to the release operation position,
the pressing portion of the knob pushes the pressure receiving surface while sliding on the pressure receiving surface of the rotor to rotate the rotor from the lock input position to the release input position, and
a length, obtained by projecting a sliding locus of the pressing portion on the pressure receiving surface on a cross-section in an axial perpendicular direction of the rotor, is not less than 0.8 times a length, by which the position of the pressing portion has been actually changed.

2. The lock mechanism according to claim 1, wherein
during the opening operation, the pressing portion changes its position toward the rotor rotation axis.

3. The lock mechanism according to claim 1, wherein
the pressure receiving surface has a curved surface shape.

4. A side lock mechanism of a glove box, comprising:
the lock mechanism according to claim 1.
